(19) United States
(12) Patent Application Publication
(10) Pub. No.: US 2012/0174639 A1
(43) Pub. Date: Jul. 12, 2012

(54) Food Waste Concentration System and Related Processes

(76) Inventor: John R. Herron, Corvallis, OR (US)

(21) Appl. No.: 13/348,615

(22) Filed: Jan. 11, 2012

Related U.S. Application Data
(60) Provisional application No. 61/431,593, filed on Jan. 11, 2011.

(51) Int. Cl. C05F 9/04; C05F 9/02

(52) U.S. Cl. 71/14; 435/290.1; 210/631

(57) ABSTRACT

A forward osmosis system and process for producing fertilizer and recycling water from a food waste methane digester wastewater stream. The process includes: forming a residual wastewater stream from food waste using digesters; coarse filtering the residual wastewater stream; acid treating the filtered, residual wastewater stream so that ammonium is retained therein; diverting the acid treated, filtered, residual wastewater stream to one side of at least one forward osmosis membrane; and concentrating the acid treated, filtered, residual wastewater stream to form fertilizer by contacting a saturated salt brine in a forward osmosis draw loop to an opposite side of the at least one forward osmosis membrane and osmotically pulling water across the at least one forward osmosis membrane from the acid treated, filtered, residual wastewater stream to the saturated salt brine, thereby diluting the saturated salt brine.

### CROSS-REFERENCE TO RELATED APPLICATION

This application claims priority to the pending provisional application entitled “Food Waste Concentration System and Related Processes”, Ser. No. 61431593, filed Jan. 11, 2011, the entire disclosure of which is hereby incorporated herein by reference.

### BACKGROUND

1. Technical Filed

This document relates to food waste concentration systems and related processes that use osmotic pressure to enable transport of desired chemical components of a mixture across a membrane.

2. Background

Interest in production of electricity from biomass has dramatically increased recently. One particularly attractive application is the digestion of food-processing waste streams to produce methane. The waste is introduced to large tanks where anaerobic digesters (e.g., bacteria) consume the organics, releasing methane and carbon dioxide gas. The gas is collected and burned in a modified diesel generator to produce electricity. Once the organics in the waste are broken down, what remains is a wastewater solution of nutrients and salts that must be disposed of.

The wastewater is saturated with ultra fine materials that will blind and/or foul most known filtration equipment. Therefore, currently, the most common disposal technique is to land-apply the solution. However, the solution has minimal value as irrigation water and can cause pollution problems if the nutrients are washed into streams or rivers.

### SUMMARY

Aspects of this document relate to food waste concentration systems and related processes that provide for the combined and simultaneous treatment of wastewater from anaerobic digestion, reverse osmosis membrane water treatment waste brines, and the production of high-grade fertilizer. These aspects may include, and implementations may include, one or more or all of the components and steps set forth in the appended CLAIMS, which are hereby incorporated by reference.

In one aspect, a forward osmosis food waste concentration system for producing fertilizer and recycling water from an incoming food waste methane digester wastewater stream is disclosed. The system may include a digester stage including a digesting operation configured to produce a residual wastewater stream from food waste. A coarse filtering stage may be coupled to the digester stage and is configured to receive the residual wastewater stream. The coarse filtering stage may include a screening operation configured to produce a filtered, residual wastewater stream. An acid treatment stage may be coupled to the coarse filtering stage and is configured to receive the filtered, residual wastewater stream. The acid treatment stage may include a treatment operation configured to retain ammonium and produce an acid treated, filtered, residual wastewater stream. A forward osmosis stage may be coupled to the acid treatment stage and is configured to receive the acid treated, filtered, residual wastewater stream from the acid treatment stage. The forward osmosis stage may include a forward osmosis operation configured to: divert the acid treated, filtered, residual wastewater stream to one side of at least one forward osmosis membrane; and contact an opposite side of the at least one forward osmosis membrane with a saturated salt brine stream in a forward osmosis draw loop and osmotically pull water across the at least one forward osmosis membrane from the acid treated, filtered, residual wastewater stream to the saturated salt brine stream using only a concentration gradient; and thereby produce a fertilizer stream and a diluted, saturated salt brine stream.

Particular implementations may include one or more or all of the following.

The system may further include a reverse osmosis stage coupled to the forward osmosis stage configured to receive the diluted, saturated salt brine stream from the forward osmosis stage. The reverse osmosis stage may include a reverse osmosis operation configured to pump under pressure the diluted, saturated salt brine stream to at least one reverse osmosis membrane and produce a re-concentrated saturated salt brine stream and a recycled purified water stream for reuse.

The saturated salt brine stream may include a saturated potassium chloride brine stream.

The at least one forward osmosis membrane may be a semipermeable membrane. The at least one forward osmosis membrane may be a cellulosic membrane. The at least one forward osmosis membrane may be a spiral wound membrane.

The at least one forward osmosis membrane may include a plurality of forward osmosis membranes. The plurality of forward osmosis membranes may operate in a parallel flow configuration.

In another aspect, a process for producing fertilizer and recycling water from an incoming food waste methane digester wastewater stream is disclosed. The process includes: forming a residual wastewater stream from food waste using digesters; coarse filtering the residual wastewater stream; acid treating the filtered, residual wastewater stream so that ammonium is retained therein; diverting the acid treated, filtered, residual wastewater stream to one side of at least one forward osmosis membrane; and concentrating the acid treated, filtered, residual wastewater stream to form fertilizer by contacting a saturated salt brine in a forward osmosis draw loop to an opposite side of the at least one forward osmosis membrane and osmotically pulling water across the at least one forward osmosis membrane from the acid treated, filtered, residual wastewater stream to the saturated salt brine, thereby diluting the saturated salt brine.

Particular implementations may include one or more or all of the following.

The process may further include: pumping under pressure the diluted, saturated salt brine to at least one reverse osmosis membrane; and re-concentrating the diluted, saturated salt brine to appropriate draw strength and producing purified water for reuse.

The step of acid treating the filtered, residual wastewater stream may include acid treating the filtered, residual wastewater stream using an organically certifiable acid so that ammonium is retained therein.

The step of concentrating the acid treated, filtered, residual wastewater stream may include concentrating the acid treated, filtered, residual wastewater stream to form fertilizer by contacting a saturated potassium chloride brine in a forward osmosis draw loop to an opposite side of the at least one forward osmosis membrane and osmotically pulling water across the at least one forward osmosis membrane from the acid treated, filtered, residual wastewater stream to the saturated potassium chloride brine, thereby diluting the saturated potassium chloride brine.

Implementations of food waste concentration systems and processes may have one or more or all of the following advantages.

Wastewater from a food waste methane digester may be converted into a useful fertilizer by Forward Osmosis (FO). If Potassium Chloride brine is used as the osmotic agent, that fertilizer can be certified as organic. The ammonium may be retained in the waste with minimal acid addition by performing the acidification required by the end reverse osmosis (RO) process only on the Potassium Chloride brine.

Water from waste streams may be recycled into clean brine streams of desired purity to be used as a process fluid without requiring the expenditure of large amounts of energy. For example, reconcentration of the diluted brine stream by RO can deliver a purified water stream that can be reused in a food processing plant.

Economically, because the osmosis process is used, no power inputs are required. Water moves from the waste to the brine due to a concentration gradient and not due to applied pressure or heat. The only power required is for transfer pumps to move the fluids into the system.

The total costs of disposal may be reduced because the volumes of waste products for disposal are reduced.

The foregoing and other aspects, features, and advantages will be apparent to those of ordinary skill in the art from the DESCRIPTION and DRAWINGS, and from the CLAIMS.

### BRIEF DESCRIPTION OF DRAWINGS

Implementations will hereinafter be described in conjunction with the appended DRAWINGS (which are not necessarily to scale), where like designations denote like elements.

FIG. 1 is a schematic block diagram of an implementation of an ?;

### DESCRIPTION

This document features a food waste concentration system and related processes. Instead of disposing of waste water from the digestion of food-processing waste streams for example, food waste concentration systems and related process implementations use both forward osmosis (FO) with reverse osmosis (RO) for the simultaneous production of fertilizer and advanced water treatment. This integration of processes into a single system concentrates salts and nutrients in a wastewater stream to produce a high-value fertilizer (e.g., organic) and a water stream that can be reused (e.g., in a food plant). There are many features of food waste concentration system and related process implementations disclosed herein, of which one, a plurality, or all features or steps might be used in any particular implementation.

In the following description, reference is made to the accompanying DRAWINGS which form a part hereof, and which show by way of illustration possible implementations. It is to be understood that other implementations may be utilized, and structural, as well as procedural, changes may be made without departing from the scope of this document. As a matter of convenience, various components will be described using exemplary materials, sizes, shapes, dimensions, and the like. However, this document is not limited to the stated examples and other configurations are possible and within the teachings of the present disclosure.

### Overview

The most common technique for concentration of solutions is evaporation. Heat is applied to the solution, boiling off water and leaving the dissolved salts behind. Typically the water is condensed and used to supply part of the heat for further evaporation. In the case of food-waste digestate, however, the predominate salt is ammonium bicarbonate, which, if boiled, will gas off as ammonia and carbon dioxide. This makes evaporation impractical because it loses much of the fertilizer value and causes air pollution problems from the released ammonia.

Another possible concentration technology which is inappropriate for this application is reverse osmosis (RO) which concentrates solutions by applying very high pressures to force water from the solution through a semi-permeable membrane. RO is not appropriate for this application because of two fundamental problems: fouling and salt passage.

RO is very susceptible to fouling because the high pressures applied cause any solids in the solution to become impacted on the membrane and eventually seal it off. This is particularly a problem because as the solution becomes concentrated salts may precipitate out of solution and form an impermeable layer on the membrane surface.

Salt passage by RO in this application refers to the loss of ammonia and carbon dioxide through the membrane. Ionic species are primarily prevented from passing through the semi-permeable membrane by their ionic charge, however ammonia and carbon dioxide pass readily. The pH of the digestate (˜pH 8) causes an appreciable portion of the ammonium bicarbonate to be in solution as ammonia and carbon dioxide, and these species will continually pass through the membrane with the water. It is possible to retain the ammonia by acidifying the solution, but this is undesirable due to the expense of the acid and the addition of unwanted anions.

### Systems And Processes

Forward Osmosis (FO) concentration, however, is an appropriate method of concentrating salts and nutrients in such wastewater streams to produce a high-value fertilizer and a water stream that could be reused. FO is a membrane technology that uses membranes with similar selectivity to those used in RO. But instead of applying high pressure to squeeze water from a solution, FO uses a solution with high osmotic potential to draw water through the membrane from a solution of low osmotic potential. Thus, FO can provide for non-membrane fouling fertilizer production in combination with water treatment and high quality water recovery using RO.

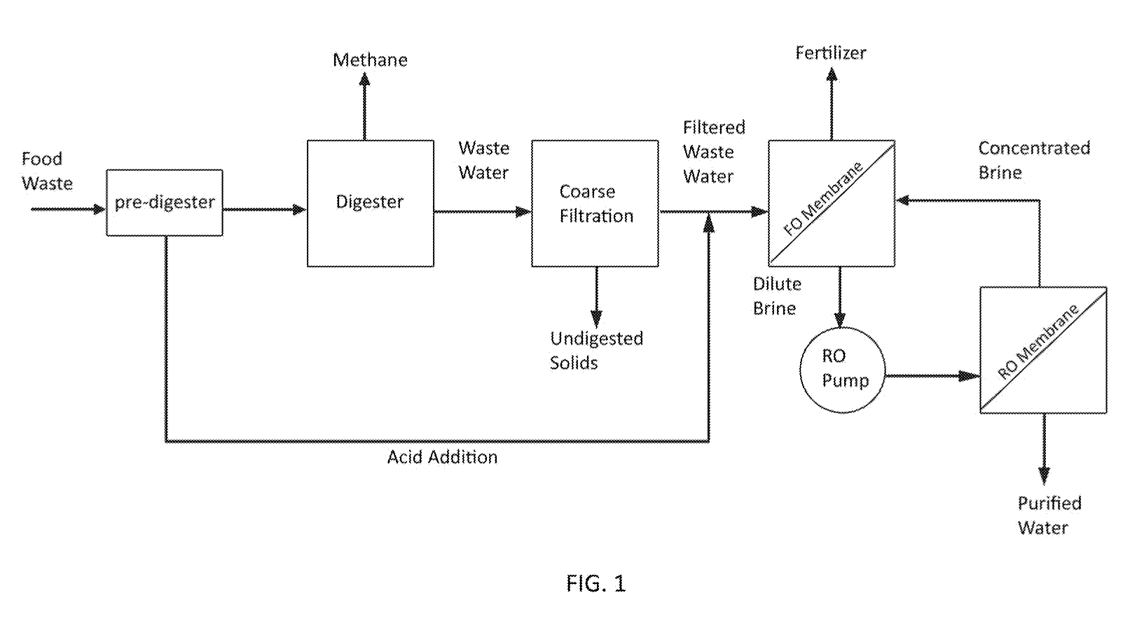

There are a variety of food waste concentration system implementations. Notwithstanding, turning to FIG. 1 and for the exemplary purposes of this disclosure, food waste concentration system implementation and its related process is shown. In this system, FO is used in conjunction with RO to concentrate the waste stream and achieve high quality water recovery.

First, bacteria or other digesters digest the food waste or other appropriate waste. For example, primary settling and one or more stages of anaerobic digestion may occur first in a standard anaerobic digester system having a tank with water baffles for example followed by a tank with a variable surface lid for example to account for the heat and gases (e.g. methane, carbon dioxide, etc.) from the digesters.

The released methane gas can be collected and burned in a modified diesel generator for example to produce electricity. The residue is separated into a sludge and a clarified, residual wastewater stream (the digester centrate).

This residual wastewater stream is then decanted off and pumped through a coarse or rough filtering or screening operation (e.g., an auger screen). For example, 200 to 400 micron screening may be done at this stage and is a common practice for recovery of larger particles of plant and animal waste commonly entrained in the liquid centrate drained for food processing related digesters. Shaker screens may also be used to remove solids particles down to about 100 microns. The resulting larger undigested particles that were screened (the reject) may be diverted to an air drying bin for example.

The filtered or screened wastewater stream is diverted to a separation tank for example. The process for recovery of usable water from this wastewater or centrate is enabled in the separation tank by the use of acidification. By using organically certifiable acetic acid (and/or possibly other organically certified acid products (e.g., phosphoric acid citric acid, sulfuric acid, and the like) alone or for balancing purposes), the acidification process remains organically certifiable. This will result in the correct balance of components (e.g. phosphors, sulfurs, and the like) in the system and achieve the final fertilizer needs and N:P:K(:S) ratios. Thus, the ammonium can be retained in the wastewater stream with minimal acid addition by performing the acidification required by the end RO process only on the brine.

FO then concentrates the acid treated wastewater stream. The FO process (also termed direct osmotic concentration) has been described in an earlier patent (Herron et al. U.S. Pat. No. 5,821,430), which is hereby incorporated by reference.

The FO process involves selective mass transfer across a membrane that allows a desired component to cross the membrane from a solution of higher concentration of the component to a solution of lower concentration. A semi-permeable membrane allows water to pass but blocks the movement of dissolved species.

The membrane may have a design similar to that disclosed in U.S. Pat. No. 4,033,878 to Foreman et al., entitled “Spiral Wound Membrane Module for Direct Osmosis Separations,” issued Jul. 5, 1977, the disclosure of which is hereby incorporated entirely herein by reference. A spiral wound membrane design configuration is inexpensive and can provide one of the greatest membrane surface areas in a vessel per cost (it can have a high membrane density (about 30 m² per 20 cm diameter by 100 cm long element)).

In general, a spiral wound configuration, a permeate spacer, a feed spacer and two membranes can be wrapped around a perforated tube and glued in place. The membranes are wound between the feed spacer and the permeate spacer. Feed fluid is forced to flow longitudinally through the module through the feed spacer, and fluid passing through the membranes flows inward in a spiral through the permeate spacer to the center tube. To prevent feed fluid from entering the permeate spacer, the two membranes are glued to each other along their edges with the permeate spacer captured between them. The feed spacer remains unglued. Module assemblies are wound up to a desired diameter and the outsides are sealed.

In use, the membrane forces a draw solution (i.e., brine) to flow through the entire, single membrane envelope. The brine is pumped into one end of a center tube with perforations. A barrier element fixed halfway down the tube forces the brine flow through the perforations into the membrane envelope. A glue barrier is applied to the center of the membrane envelope so that fluid must flow to the far end of the membrane where a gap allows it to cross over to the other side of the membrane envelope then back into the second half of the center tube and out of the element. While a single envelope can be employed, there may be multiple envelopes wound/wrapped around the center tube with feed fluid spacers between the envelopes. Furthermore, a plurality of membranes may be used and may operate in a parallel flow configuration.

Here in FIG. 1, because the driving force causing the transfer of mass through the FO membrane is osmotic pressure, no additional energy input is required to cause the transfer to occur beyond what is required to place the solutions in contact with the membrane (through transfer pumps, etc.). Water moves from the waste to the brine due to a concentration gradient and not due to applied pressure or heat or any other power input.

As a result, as saturated salt brine is contacted to one side of the FO membrane and dilute wastewater is contacted to the opposite side, water will diffuse through the membrane from the wastewater to the brine. The semi-permeable membrane will keep unwanted impurities and sediment in the wastewater, thus, producing clean diluted brine. Depending upon the material used for the membrane, the structure of the membrane, and the arrangement of the membrane within the system, the amount and rate of transfer may be enhanced and/or controlled.

Specifically, at the point of acidification, the majority of the solids have been removed, but the supernatant in the primary separation tank still contains a great deal of potentially high fouling materials that are fine enough to pass most filters but large enough to cause fouling of most membrane processes. FO provides membrane rejection and recovery of these partials and ionic contaminates while allowing over 90% of the water to be recovered and then produced by the downstream RO system, which re-concentrates the high osmotic potential draw solution, osmotic agent, or saturated brine stream to drive the FO. Thus, this food waste concentration system implementation uses FO to move water from the acid treated wastewater stream into a high osmotic potential draw solution, osmotic agent, or saturated brine stream across a FO membrane, creating a concentrated wastewater stream and a dilute brine stream. The brine stream may be composed of an organic certification compatible potash salt (e.g. potassium chloride brine).

During the process, the supernatant is flowed through the FO membrane element. The brine (high osmotic potential draw solution) from RO reject is drawn through the other side of the FO element (i.e. on the other side of the FO membrane within the element). Water drawn across the membrane due to osmotic pull will dilute the brine, which is then returned to a brine tank for example. The brine is re-concentrated and maintained in this FO draw solution loop. Fertilizer (e.g. organic fertilizer) is simultaneously produced in the form of components not drawn across the FO membrane.

For the recovery of water then, FO is followed by the collection of the diluted brine into the brine tank. Re-concentration of the brine after it absorbs water from the wastewater stream is accomplished by RO. Diluted brine from the brine tank is pumped under pressure to the RO elements where it is re-concentrated to appropriate draw strength, and the clean product water is simultaneously produced. This completes the recovery of wastewater to high-grade reuse water. Thus, the RO equipment produces a purified water stream that can be reused in the food plant.

The advantage that FO/RO concentration of the fertilizer has over simple RO concentration is twofold. First, FO operates at low pressures thereby reducing fouling of the membrane. The only pressures applied are to provide circulation and are typically 1 to 2 Bar. Second, RO would require the carbonate ions in the waste to be fully acidified to carbon dioxide to prevent precipitation on the membrane. In the RO/FO concentrator, the acidification can be made to the brine only, and far less acid is required.

Thus, the wastewater can be from a food waste methane digester and FO can convert it into a useful fertilizer. Potassium Chloride brine can be used as the osmotic agent so that the fertilizer can be certified as Organic. The diluted brine can be re-concentrated by RO, delivering a purified water stream that can be reused in the food processing plant.

### EXAMPLE

A landfill system for the concentration of landfill leachate was designed to process 150,000 l/day into two streams; 8000 l of concentrate and 142000 l of water for irrigation. The concentrate was solidified with cement and reapplied to the landfill.

The feed stream was a landfill leachate with an average conductivity of 8 milliSiemens. The leachate was acidified, then 92% to 95% of the water was removed by FO. The brine used was a sodium chloride solution which was reconcentrated by RO operating at a pressure of 75 bar. The RO permeate was twice purified by further RO filters and discharged as irrigation water. The discharge water had an average TDS of 10 ppm.

### Specifications Materials Manufacture Assembly

It will be understood that implementations are not limited to the specific components disclosed herein, as virtually any components consistent with the intended operation of a food waste concentration system may be utilized. Accordingly, for example, although particular components and so forth, are disclosed, such components may comprise any shape, size, style, type, model, version, class, grade, measurement, concentration, material, weight, quantity, and/or the like consistent with the intended operation of a food waste concentration system implementation. Implementations are not limited to uses of any specific components, provided that the components selected are consistent with the intended operation of a food waste concentration system implementation.

Accordingly, the components defining any food waste concentration system implementation may be formed of any of many different types of materials or combinations thereof that can readily be formed into shaped objects provided that the components selected are consistent with the intended operation of a food waste concentration system implementation. For example, the components may be formed of: rubbers (synthetic and/or natural) and/or other like materials; glasses (such as fiberglass), carbon-fiber, aramid-fiber, any combination thereof, and/or other like materials; polymers such as thermoplastics (such as ABS, Acrylic, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals and/or other like materials; alloys and/or other like materials; any other suitable material; and/or any combination thereof.

For the exemplary purposes of this disclosure, as a restatement of or in addition to what has already been described and disclosed above, the FO or PRO membranes used in various implementations may be constructed of a wide variety of materials and have a wide variety of operating characteristics. For example, the membranes may be semi-permeable, meaning that they pass substantially exclusively the components that are desired from the solution of higher concentration to the solution of lower concentration, for example, passing water from a more dilute solution to a more concentrated solution. Any of a wide variety of membrane types may be utilized using the principles disclosed in this document.

Also, as a restatement of or in addition to what has already been described and disclosed above, the FO or PRO membranes used in various implementations may be made from a thin film composite RO membrane. Such membrane composites include, for example, a membrane cast by an immersion precipitation process (which could be cast on a porous support fabric such as woven or nonwoven nylon, polyester or polypropylene, or preferably, a cellulose ester membrane cast on a hydrophilic support such as cotton or paper). The membranes used may be hydrophilic, membranes with salt rejections in the 80% to 95% range when tested as a reverse osmosis membrane (60 psi, 500 PPM NaCl, 10% recovery, 25.degree. C.). The nominal molecular weight cut-off of the membrane may be 100 daltons. The membranes may be made from a hydrophilic membrane material, for example, cellulose acetate, cellulose proprianate, cellulose butyrate, cellulose diacetate, blends of cellulosic materials, polyurethane, polyamides. The membranes may be asymmetric (that is, for example, the membrane may have a thin rejection layer on the order of one (1) or less microns thick and a dense and porous sublayers up to 300 microns thick overall) and may be formed by an immersion precipitation process. The membranes are either unbacked, or have a very open backing that does not impede water reaching the rejection layer, or are hydrophilic and easily wick water to the membrane. Thus, for mechanical strength they may be cast upon a hydrophobic porous sheet backing, wherein the porous sheet is either woven or non-woven but having at least about 30% open area. The woven backing sheet may be a polyester screen having a total thickness of about 65 microns (polyester screen) and total asymmetric membrane is 165 microns in thickness. The asymmetric membrane may be cast by an immersion precipitation process by casting a cellulose material onto a polyester screen. The polyester screen may be 65 microns thick, 55% open area.

For the exemplary purposes of this disclosure, the brines may generally be inorganic salt based or sugar-based. For example, a brine may be Sodium chloride=6.21 wt %; Potassium chloride=7.92 wt %, Trisodium citrate=10.41 wt %, Glucose=58.24 wt %, Fructose=17.22 wt %, and the like.

Various food waste concentration system implementations may be manufactured using conventional procedures as added to and improved upon through the procedures described here. Some components defining food waste concentration system implementations may be manufactured simultaneously and integrally joined with one another, while other components may be purchased pre-manufactured or manufactured separately and then assembled with the integral components.

Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener, wiring, any combination thereof, and/or the like for example, depending on, among other considerations, the particular material forming the components.

For the exemplary purposes of this disclosure, in one implementation a process for making a spiral wound membrane filter element or module may include: (a) assembling an envelope sandwich; (b) assembling a center tube onto the envelope sandwich; and (c) wrapping the envelope sandwich having the center tube and glue to form the spiral wound membrane module.

### Use

Implementations of a food waste concentration system are particularly useful in food processing applications. The synergistic FO/RO system and process implementations are uniquely valuable to organic food production and processing operations, and represent a significant potential advance in sustainable food process technology.

However, implementations are not limited to uses relating to food processing and FO applications. Rather, any description relating to food processing and FO applications is for the exemplary purposes of this disclosure, and implementations may also be used with similar results in a variety of other FO/water treatment applications, such as osmotic-driven water purification and filtration, desalination of sea water, purification of contaminated aqueous waste streams, industrial and energy applications, and the like. Implementations may also be used for PRO systems. The difference is that PRO generates osmotic pressure to drive a turbine or other energy-generating device. All that would be needed is to switch to feeding fresh water (as opposed to osmotic agent) and the salt water feed can be fed to the outside instead of source water (for water treatment applications).

In places where the description above refers to particular implementations, it should be readily apparent that a number of modifications may be made without departing from the spirit thereof and that these implementations may be alternatively applied. The accompanying CLAIMS are intended to cover such modifications as would fall within the true spirit and scope of the disclosure set forth in this document. The presently disclosed implementations are, therefore, to be considered in all respects as illustrative and not restrictive, the scope of the disclosure being indicated by the appended CLAIMS rather than the foregoing DESCRIPTION. All changes that come within the meaning of and range of equivalency of the CLAIMS are intended to be embraced therein.

1. A forward osmosis food waste concentration system for producing fertilizer and recycling water from an incoming food waste methane digester wastewater stream comprising:
a digester stage comprising a digesting operation configured to produce a residual wastewater stream from food waste;
a coarse filtering stage coupled to the digester stage and configured to receive the residual wastewater stream, the coarse filtering stage comprising a screening operation configured to produce a filtered, residual wastewater stream;
an acid treatment stage coupled to the coarse filtering stage configured to receive the filtered, residual wastewater stream and comprising a treatment operation configured to retain ammonium and produce an acid treated, filtered, residual wastewater stream; and
a forward osmosis stage coupled to the acid treatment stage configured to receive the acid treated, filtered, residual wastewater stream from the acid treatment stage, the forward osmosis stage comprising a forward osmosis operation configured to:
divert the acid treated, filtered, residual wastewater stream to one side of at least one forward osmosis membrane; and
contact an opposite side of the at least one forward osmosis membrane with a saturated salt brine stream in a forward osmosis draw loop and osmotically pull water across the at least one forward osmosis membrane from the acid treated, filtered, residual wastewater stream to the saturated salt brine stream using only a concentration gradient; and
thereby produce a fertilizer stream and a diluted, saturated salt brine stream.

2. The system of claim 1 further comprising a reverse osmosis stage coupled to the forward osmosis stage configured to receive the diluted, saturated salt brine stream from the forward osmosis stage, the reverse osmosis stage comprising a reverse osmosis operation configured to pump under pressure the diluted, saturated salt brine stream to at least one reverse osmosis membrane and produce a re-concentrated saturated salt brine stream and a recycled purified water stream for reuse.

3. The system of claim 1 wherein the saturated salt brine stream comprises a saturated potassium chloride brine stream.

4. The system of claim 1 wherein the at least one forward osmosis membrane is a semipermeable membrane.

5. The system of claim 1 wherein the at least one forward osmosis membrane is a cellulosic membrane.

6. The system of claim 1 wherein the at least one forward osmosis membrane is a spiral wound membrane.

7. The system of claim 1 wherein the at least one forward osmosis membrane comprises a plurality of forward osmosis membranes.

8. The system of claim 7 wherein the plurality of forward osmosis membranes operate in a parallel flow configuration.

9. A process for producing fertilizer and recycling water from a food waste methane digester wastewater stream comprising:
forming a residual wastewater stream from food waste using digesters;
coarse filtering the residual wastewater stream;
acid treating the filtered, residual wastewater stream so that ammonium is retained therein;
diverting the acid treated, filtered, residual wastewater stream to one side of at least one forward osmosis membrane; and
concentrating the acid treated, filtered, residual wastewater stream to form fertilizer by contacting a saturated salt brine in a forward osmosis draw loop to an opposite side of the at least one forward osmosis membrane and osmotically pulling water across the at least one forward osmosis membrane from the acid treated, filtered, residual wastewater stream to the saturated salt brine, thereby diluting the saturated salt brine.

10. The process of claim 9 further comprising:
pumping under pressure the diluted, saturated salt brine to at least one reverse osmosis membrane; and
re-concentrating the diluted, saturated salt brine to appropriate draw strength and producing purified water for reuse.

11. The process of claim 9 wherein the step of acid treating the filtered, residual wastewater stream comprises acid treating the filtered, residual wastewater stream using an organically certifiable acid so that ammonium is retained therein.

12. The process of claim 9 wherein the step of concentrating the acid treated, filtered, residual wastewater stream comprises concentrating the acid treated, filtered, residual wastewater stream to form fertilizer by contacting a saturated potassium chloride brine in a forward osmosis draw loop to an opposite side of the at least one forward osmosis membrane and osmotically pulling water across the at least one forward osmosis membrane from the acid treated, filtered, residual wastewater stream to the saturated potassium chloride brine, thereby diluting the saturated potassium chloride brine.
